(19) United States
(12) Patent Application Publication
(10) Pub. No.: US 2026/0342822 A1
(43) Pub. Date: Oct. 29, 2026

(54) CONTAINER ORCHESTRATION PLATFORM-RELATED ACCESS CONTROL AND ANOMALY DETECTION USING ARTIFICIAL INTELLIGENCE

(71) Applicant: Dell Products L.P., Round Rock, TX (US)

(72) Inventors: Sudeepta Khuntia, Bangalore (IN); Balakrishna Deshamouni, Shrewsbury, MA (US); Dariusz Dudzinski, Radzyn Podlaski (PL); Norbert Piotrowski, Kielce (PL); Khoa Kennedy, Worcester, MA (US); Hung T. Dinh, Austin, TX (US); Bijan Kumar Mohanty, Austin, TX (US); Aaron Byrd, Norman, OK (US)

(21) Appl. No.: 19/188,546

(22) Filed: Apr. 24, 2025

(51) Int. Cl. H04L 9/40

(52) U.S. Cl. CPC H04L 63/1425; H04L 63/105

(57) ABSTRACT

Methods, apparatus, and processor-readable storage media for container orchestration platform-related access control and anomaly detection using artificial intelligence are provided herein. An example computer-implemented method includes processing, using at least one RBAC operator, one or more cluster changes within at least one container orchestration platform; updating one or more permissions granted to one or more namespace users, within the at least one container orchestration platform, in response to at least a portion of the one or more cluster changes; identifying, in accordance with the one or more updated permissions, anomalous operation-related activity within the at least one container orchestration platform using one or more artificial intelligence-based anomaly detection techniques; and performing one or more automated actions in response to at least a portion of the identified anomalous operation-related activity.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Container orchestration platforms such as, e.g., Kubernetes, are commonly used by application developers and platform operators. However, access control presents challenges for such platforms in multi-tenant contexts, and conventional container orchestration platform approaches often result in data loss, latencies and/or other security issues.

### SUMMARY

Illustrative embodiments of the disclosure provide techniques for container orchestration platform-related access control and anomaly detection using artificial intelligence.

An example computer-implemented method includes processing, using at least one role-based access control (RBAC) operator, one or more cluster changes within at least one container orchestration platform, and updating one or more permissions granted to one or more namespace users, within the at least one container orchestration platform, in response to at least a portion of the one or more cluster changes. The method also includes identifying, in accordance with the one or more updated permissions, anomalous operation-related activity within the at least one container orchestration platform using one or more artificial intelligence-based anomaly detection techniques. Further, the method includes performing one or more automated actions in response to at least a portion of the identified anomalous operation-related activity.

Illustrative embodiments can provide significant advantages relative to conventional container orchestration platform approaches. For example, problems associated with data loss, latencies and/or other security issues arising from failure to implement preventative measures with respect to security breaches are overcome in one or more embodiments through maintaining updated namespace permissions information and automatically detecting operations-related anomalies in association therewith.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for container orchestration platform-related access control and anomaly detection using artificial intelligence in an illustrative embodiment.

FIG. 2 shows an example system architecture in an illustrative embodiment.

FIG. 3 shows example pseudocode for implementing at least one cluster role in an illustrative embodiment.

FIG. 4 shows an example framework architecture for building one or more application programming interfaces (APIs) in an illustrative embodiment.

FIG. 5 shows an example object builder cluster architecture and workflow in an illustrative embodiment.

FIG. 6 shows example pseudocode for configuring log data and converting log data to a data frame in an illustrative embodiment.

FIG. 7 shows example pseudocode for training an isolation forest algorithm in an illustrative embodiment.

FIG. 8 shows example pseudocode for implementing the trained isolation forest algorithm for anomaly detection in an illustrative embodiment.

FIG. 9 shows an example output table in an illustrative embodiment.

FIG. 10 is a flow diagram of a process for container orchestration platform-related access control and anomaly detection using artificial intelligence in an illustrative embodiment.

FIGS. 11 and 12 show examples of processing platforms that may be utilized to implement at least a portion of an information processing system in illustrative embodiments.

### DETAILED DESCRIPTION

Illustrative embodiments will be described herein with reference to example computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

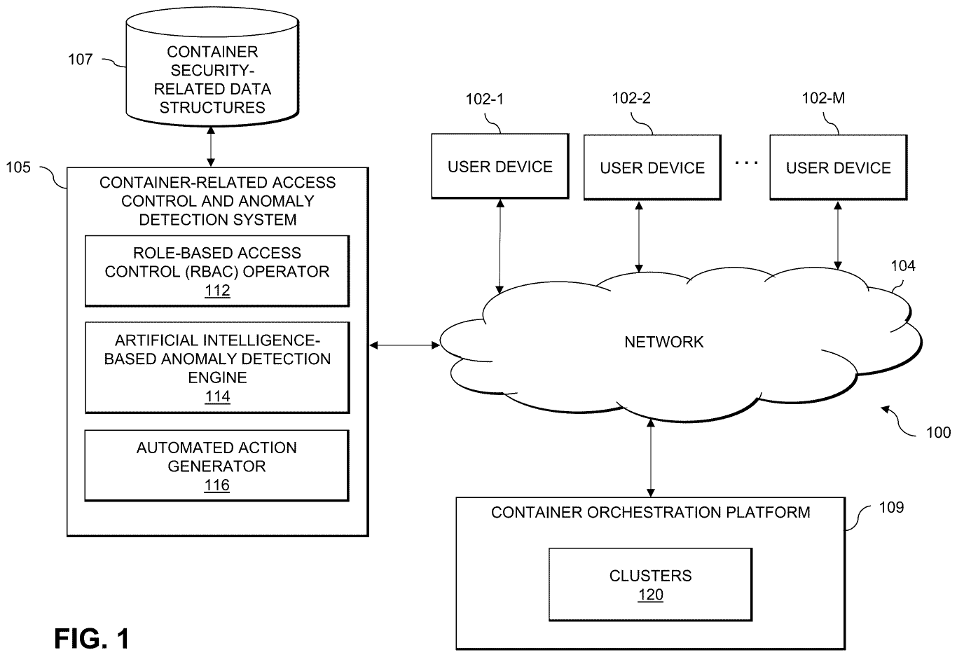

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is container-related access control and anomaly detection system 105 and at least one container orchestration platform 109, which includes one or more clusters 120.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the container-related access control and anomaly detection system 105 can have one or more container security-related data structures 107 configured to store data pertaining to access permissions, user role data, blacklist data, whitelist data, user geographic region-related data, temporal operation-related data, etc. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The container security-related data structures 107 in the present embodiment are implemented using one or more storage systems associated with the container-related access control and anomaly detection system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the container-related access control and anomaly detection system 105 are one or more input-output devices, which illustratively comprise keyboards, displays or other types of input-output devices in any combination. Such input-output devices can be used, for example, to support one or more user interfaces to the container-related access control and anomaly detection system 105, as well as to support communication between the container-related access control and anomaly detection system 105 and other related systems and devices not explicitly shown.

Additionally, the container-related access control and anomaly detection system 105 in the FIG. 1 embodiment is assumed to be implemented using at least one processing device. Each such processing device generally comprises at least one processor and an associated memory, and implements one or more functional modules for controlling certain features of the container-related access control and anomaly detection system 105.

More particularly, the container-related access control and anomaly detection system 105 in this embodiment can comprise a processor coupled to a memory and a network interface.

The processor may comprise, for example, a microprocessor, an application-specific integrated circuit (ASIC), a system-on-chip (SOC), a field-programmable gate array (FPGA), a central processing unit (CPU), a graphics processing unit (GPU), a neural processing unit (NPU), a data processing unit (DPU), a tensor processing unit (TPU), an arithmetic logic unit (ALU), a digital signal processor (DSP), and/or other similar processing device components, as well as other types and arrangements of processing circuitry, in any combination. At least a portion of the functionality of at least one artificial intelligence system and its associated artificial intelligence algorithms provided by one or more processing devices as disclosed herein can be implemented using such circuitry.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the container-related access control and anomaly detection system 105 to communicate over the network 104 with the user devices 102, and illustratively comprises one or more conventional transceivers.

The container-related access control and anomaly detection system 105 further comprises RBAC operator 112, artificial intelligence-based anomaly detection engine 114, and automated action generator 116.

In at least one embodiment, and as further detailed herein, RBAC operator 112 can be implemented to process one or more cluster changes within at least one container orchestration platform and update one or more permissions granted to one or more namespace users, within the at least one container orchestration platform, in response to at least a portion of the one or more cluster changes. Also, in such an embodiment, artificial intelligence-based anomaly detection engine 114 can be implemented to identify, in accordance with the one or more updated permissions, anomalous operation-related activity within the at least one container orchestration platform. Further, in such an embodiment, automated action generator 116 can be implemented to perform one or more automated actions in response to at least a portion of the identified anomalous operation-related activity.

It is to be appreciated that this particular arrangement of elements 112, 114 and 116 illustrated in the container-related access control and anomaly detection system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for container orchestration platform-related access control and anomaly detection using artificial intelligence involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of container-related access control and anomaly detection system 105, container security-related data structures 107, and container orchestration platform 109 can be on and/or part of the same processing platform.

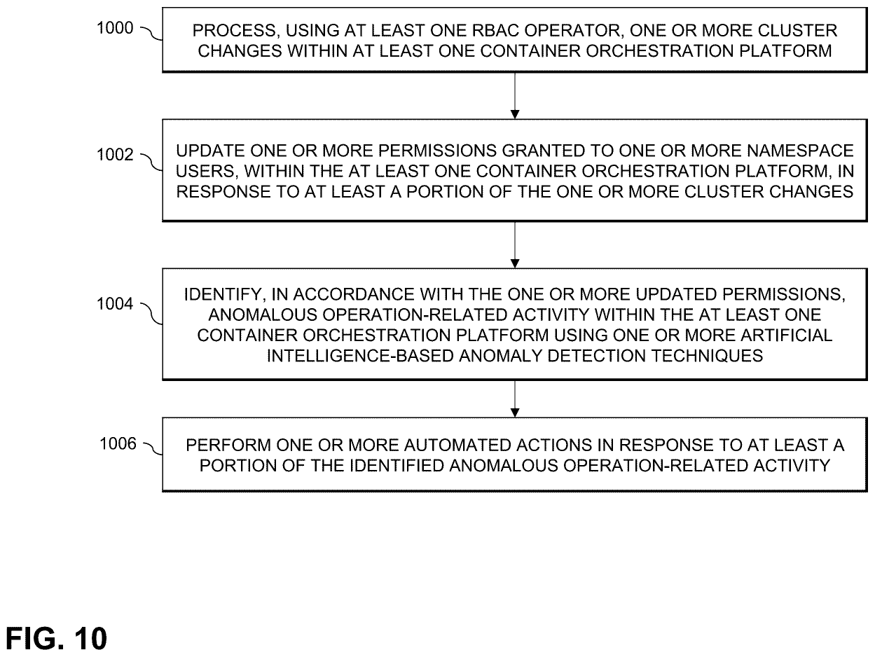

An example process utilizing elements 112, 114 and 116 of an example container-related access control and anomaly detection system 105 in computer network 100 will be described in more detail with reference to the flow diagram of FIG. 10.

Conventional container orchestration platform approaches often fail to meet all dynamic and/or evolving access requirements of the tenant users, and such conventional approaches also often fail to implement preventative measures with respect to security breaches, which can result in data loss, latencies and/or other security issues. Accordingly, at least one embodiment includes container orchestration platform-related access control and anomaly detection using artificial intelligence. For example, such an embodiment can include dynamic RBAC management and artificial intelligence-based anomaly detection for multi-tenant Kubernetes environments. More particularly, such an embodiment can include generating and/or implementing a Kubernetes namespace RBAC operator that watches for one or more changes in at least one Kubernetes cluster, and dynamically updates one or more permissions granted to one or more namespace users in response to the one or more changes. At least one embodiment includes ensuring that namespace users have access to up-to-date information pertaining to namespace-scoped API resources as well as to curated information pertaining to cluster resources that at least one administrator would like to grant to at least a portion of the namespace users. In Kubernetes, namespace-scoped API objects include resources that exist within a specific namespace and are isolated from other namespaces. These contrast, for example, with cluster-scoped objects (such as, e.g., nodes, PersistentVolumes, ClusterRoles), which are visible across the entire cluster.

Additionally, such an embodiment can include generating and/or implementing at least one artificial intelligence-based anomaly detection engine that identifies attempts for unauthorized operations based at least in part on the Kubernetes audit logs, and takes and/or initiates one or more automated actions related thereto (e.g., sends out one or more alerts).

As used herein, a namespace refers to a mechanism for isolating groups of resources within a single container orchestration system (e.g., Kubernetes) cluster. Additionally, as used herein, RBAC roles and ClusterRoles (also referred to herein as cluster roles) contain one or more rules that represent a set of one or more permissions. In at least one embodiment, such permissions are additive (i.e., there are no “deny” rules). Also, in one or more embodiments, a role always sets permissions within a particular namespace; when a role is created, the namespace it belongs in must be specified. A ClusterRole, by contrast, is a non-namespaced resource. In such an embodiment, the resources have different names (role versus ClusterRole) because a Kubernetes object always has to be either namespaced or not namespaced. In Kubernetes, a cluster refers to a complete system that runs and manages one or more containerized applications. More particularly, a cluster typically includes a master or control plane, which manages the cluster (e.g., scheduling, scaling, etc.), as well as one or more worker nodes, which run the actual application workloads (e.g., containers).

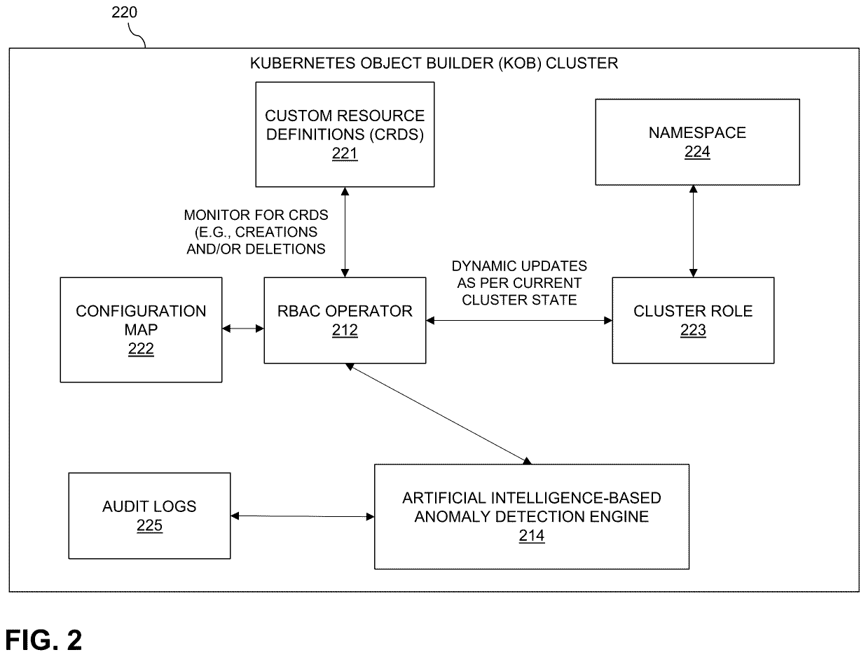

FIG. 2 shows an example system architecture in an illustrative embodiment. By way of illustration, FIG. 2 depicts a namespace RBAC operator 212, which includes a controller pattern that watches for any new API resources in the Kubernetes object builder (KOB) cluster 220, including custom resource definitions 221, and maintains a ClusterRole 223 that includes all of the API resources. Namespace RBAC operator 212 also updates the ClusterRole 223 when an API resource is deleted from the Kubernetes cluster. This ClusterRole 223 is granted to the namespace 224 as part of a RoleBinding, and as such, the namespace 224 users always have access to an up-to-date list of namespace-scoped API resources.

Further, in at least one embodiment, a Kubernetes cluster administrator might want to allow access to certain cluster-scoped API resources for the namespace 224 users. The administrator can then maintain a list of these cluster-scoped API resources in a configuration map (configmap) 222, and the namespace RBAC operator 212 monitors for changes to this configmap 222 and updates the ClusterRole 223 that is granted to the namespace 224 users. In such an embodiment, every Kubernetes operation is recorded in at least one audit log 225 as an event, and based at least in part on these events, the namespace RBAC operator 212 can implement at least one artificial intelligence-based anomaly detection engine 214 to identify any attempts for unauthorized operations and raise one or more corresponding alerts. Such an artificial intelligence-based anomaly detection engine 214 can be trained and/or configured to monitor audit logs 225 to detect and alert on one or more unauthorized operations. Also, such an artificial intelligence-based anomaly detection engine 214 can be trained and/or configured to execute event-based anomaly identification, wherein the artificial intelligence-based anomaly detection engine 214 uses events recorded in audit logs 225 to identify and respond to one or more potential security breaches.

One or more embodiments also include implementing the namespace RBAC operator 212 which dynamically updates one or more permissions and/or roles for one or more namespace 224 users based at least in part on changes (e.g., resources being added and/or removed) in at least one Kubernetes cluster 220. Also, the namespace RBAC operator 212 can maintain and update ClusterRoles 223 to include all API resources, ensuring namespace 224 users have access to the latest namespace-scoped API resources.

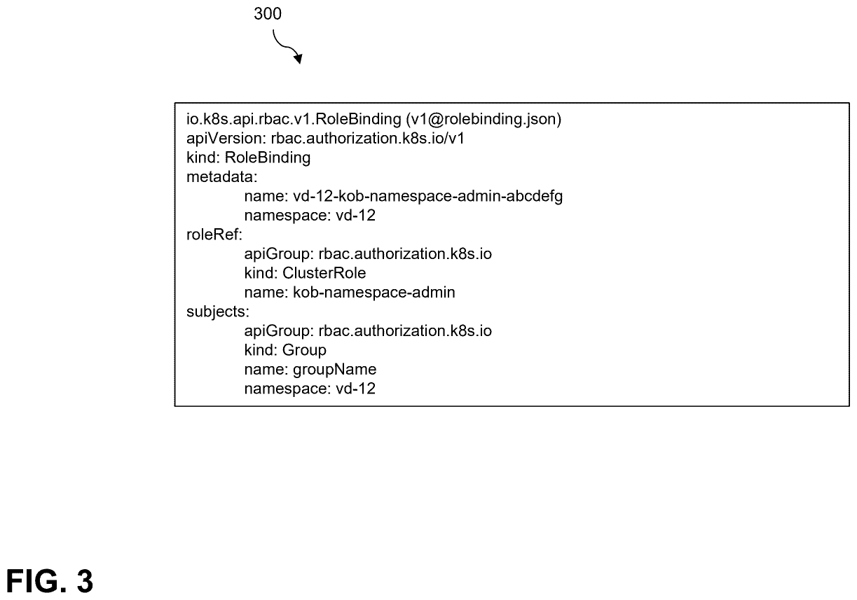

FIG. 3 shows example pseudocode for implementing at least one ClusterRole in an illustrative embodiment. In this embodiment, example pseudocode 300 is executed by or under the control of at least one processing system and/or device. For example, the example pseudocode 300 may be viewed as comprising a portion of a software implementation of at least part of container-related access control and anomaly detection system 105 of the FIG. 1 embodiment.

In connection with example pseudocode 300, regarding namespace ownership, the owner has full access to the namespaced API service installed on the given KOB cluster. At least one embodiment includes building and/or configuring a Kubernetes operator to dynamically update a Kubernetes ClusterRole anytime an API service is created, updated or deleted. Namespace KOB users will have a RoleBinding in their assigned namespace that makes a role reference to the ClusterRole that is in sync with the API service status. Also, a ClusterRole, such as depicted in connection with example pseudocode 300, can be utilized such that all namespaced role bindings can share a global configuration on rights.

It is to be appreciated that this particular example pseudocode shows just one example implementation of at least one ClusterRole, and alternative implementations can be used in other embodiments.

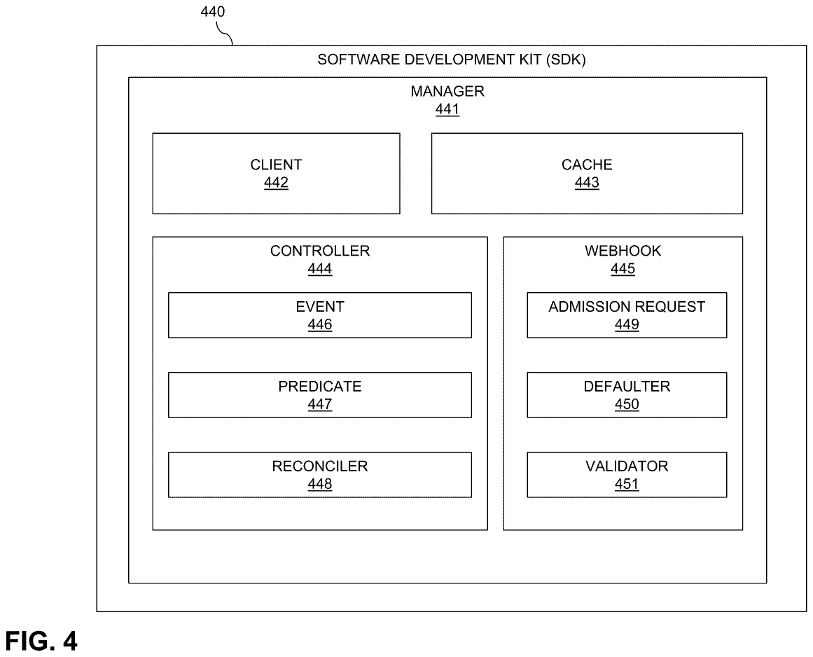

FIG. 4 shows an example framework architecture (e.g., Kubebuilder) for building one or more APIs in an illustrative embodiment. By way of illustration, FIG. 4 depicts a software development kit (SDK) 440 for building one or more APIs using one or more custom resource definitions (CRDs), one or more controllers 444 and/or one or more admission web hooks 445. With the SDK 440, a controller 444 can be created to monitor the status of a KOB API service. In such an embodiment, a control plane API server, which exposes a hypertext transfer protocol (HTTP) API that lets end users, different parts of the cluster, and external components communicate with one another.

In a controller 444 framework, at least one embodiment can include utilizing reconciler 448 logic to monitor such API services. In such an embodiment, a reconciler 448 can create and maintain Kubernetes ClusterRoles including Kob-namespace-admin, which includes permission to use verbs associated with the resource, and Kob-namespace-read-only, which includes permission limited to “get,” “list,” and/or “watch” actions. A Kubernetes ConfigMap can be maintained to allow blacklisting of resources to be added to the maintained ClusterRoles.

In one or more embodiments, two lists, an adminResourceList and a roResourceList, can be set up to store RBAC policy rules until all such rules are compiled and ready for use them in connection with one or more defined ClusterRoles. In such an embodiment, the adminResourceList can include permission(s) to use verbs associated with the resource in namespace-admin (e.g., create, read, update, delete (CRUD) operations), and the roResourceList can include permission(s) limited to “get,” “list,” and/or “watch” actions (e.g., read-only) in namespace-read-only.

Additionally, based at least in part on the following example API service events, one or more specific actions can occur and/or be carried out. For instance, in connection with a create and/or update API service event, a finalizer, if not already, is added to catch the delete event. For each of the API resources that are namespaced-scoped, the resource is skipped if it is listed in the blacklisted configmap, the resource is added to the adminResourceList and the roResourceList. With the list of policy rules, at least one embodiment includes calling at least one method to create and/or update the defined ClusterRoles. Also, if the named ClusterRole does not exist, an RBAC ClusterRole creation event takes place; otherwise, a ClusterRole update event is carried out. Further, in connection with a delete API service event, one or more embodiments include removing the finalizer.

As also depicted in FIG. 4, manager 441 (e.g., sigs.k8s.io/controller-runtime/pkg/manager) is part of a controller-runtime library used to build Kubernetes controllers (e.g., controller 444) and operators. More particularly, manager 441 sets up shared dependencies such as, e.g., caches and clients, and handles starting and managing multiple controllers in a coordinated manner, which simplifies writing custom Kubernetes logic by abstracting a boilerplate setup. Also, client 442 is used to interact with the Kubernetes API server programmatically. The client 442 allows code (e.g., controllers or operators) to create, read, update, and delete Kubernetes resources. In controller-runtime, the client 442 is used to manage resources such as, e.g., pods, deployments, and/or CRDs directly from go code, and the client 442 abstracts API calls, making it easier to write custom automation and logic.

Additionally, cache 443 improves performance by storing and watching resource data locally. More particularly, cache 443 reduces direct API server calls by serving data from memory, making controllers (e.g., controller 444) faster and more efficient. The cache 443 stays up-to-date via informers that watch for changes in real time, and in controller-runtime, the cache 443 is shared across controllers to keep data consistent and synced. Also, event 446 includes lightweight records of a state change and/or important action in the cluster. The event 446 can help with debugging and observability by showing what happened to a resource (e.g., pod created, failed, scheduled, etc.). Also, in one or more embodiments, controller 444 can use event 446 to communicate status and/or errors related to its managed resources, and users can use kubectl to get events to track what is occurring inside the cluster.

As also depicted in FIG. 4, predicate 447 is a filter that controls when controller 444 should react to event 446. More particularly, predicate 447 helps reduce unnecessary processing by letting the controller 444 respond only to relevant changes (e.g., updates with specific labels), and predicate 447 can be used with event handlers to fine-tune controller logic. In controller-runtime, the predicate 447 makes controller 444 more efficient and focused. Further, AdmissionRequest 449 is a part of Kubernetes'admission webhook mechanism, used during the API request validation or mutation process. AdmissionRequest 449 contains details about the incoming request, such as the object being created and/or updated, the user, the operation type, etc. Admission webhooks can use AdmissionRequest 449 to approve, reject, or modify the request before it is persisted, and the AdmissionRequest 449 ensures that policies, validations, and/or defaults are applied dynamically to Kubernetes resources.

Additionally, defaulter 450 (especially with controller-runtime and CRDs) is used to automatically set default values on custom resource fields. Defaulter 450 runs during the admission phase before the object is stored, and implementing the Default() method allows for defining defaults when users omit fields, which helps ensure consistency and reduces user input errors in custom resources. Further, validator 451 is used to ensure that the values in a custom resource meet specific criteria before the resource is accepted or processed. Validator 451 checks the resource's fields against one or more defined validation rules (such as type, range, required fields, etc.), and can be implemented using the Validate() method in the CRD. Also, validator 451 helps enforce data integrity and consistency by rejecting invalid configurations before they are stored or used in the cluster.

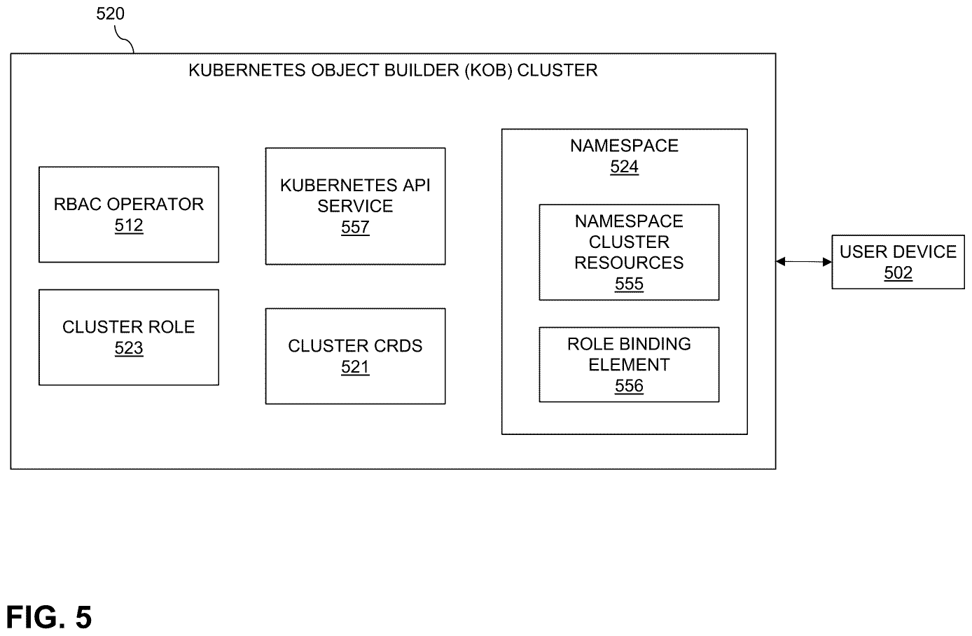

FIG. 5 shows an example object builder cluster architecture and workflow in an illustrative embodiment. By way of illustration, FIG. 5 depicts user device 502, interacting with at least a portion of KOB cluster 520, wherein KOB cluster 520 includes RBAC operator 512, cluster role 523, Kubernetes API service 557, cluster CRDs 521, and namespace 524 (which includes namespace cluster resources 555 and a role binding element 556).

More particularly, as illustrated in FIG. 5, RBAC operator 512 defines cluster role 523 with permissions at the cluster level (e.g., managing CRDs and/or nodes). The RBAC operator 512 interacts with the Kubernetes API service 557 to ensure the RBAC rules are enforced across the KOB cluster 520. Cluster CRDs 521 are created and are not bound to any particular namespace, allowing for cluster-wide management of resources. In contrast, namespace 524 provides a scope for resources (e.g., pods, services) that are limited to that namespace 524. Also, the cluster role 523 grants permissions, and role binding 556 is used to bind a user/service account to that cluster role 523 within a namespace 524. Further, the role binding 556 applies to namespace cluster resources 555 by defining what actions a user device 502 can perform on resources such as, e.g., pods and services within the namespace 524.

As detailed herein, at least one embodiment includes implementation of an artificial intelligence-based anomaly detection engine and at least one automated security-related response related to one or more detected anomalies. Such implementation can include advanced anomaly detection and automated response mechanisms as further detailed below.

For example, in accordance with one or more embodiments, anomaly detection includes implementing pattern recognition techniques. In an example embodiment, at least one isolation forest algorithm is used for unsupervised anomaly detection, including isolating one or more anomalies by randomly partitioning data and evaluating how easily two or more data points are separated. In such an embodiment, the features (e.g., user_role, event_type, resource_type, status, geo_location, etc.) are converted into a numerical format through one-hot encoding and combined with one or more temporal features (hour, weekday, etc.). An anomaly score is computed for each log entry, and one or more outliers are identified and/or flagged based at least in part on a threshold defined by the contamination parameter. Accordingly, such an embodiment includes detecting one or more abnormal behavior patterns in user activity and/or resource access, such as, e.g., unexpected access attempts, abnormal geographic locations, unusual event types, etc.

Additionally or alternatively, in accordance with one or more embodiments, anomaly detection includes implementing contextual analysis techniques. In such an embodiment, multi-feature correlation can be carried out, wherein a model incorporates multiple contextual features to improve anomaly detection accuracy. Such anomaly detection can be carried out, for example, using one or more unsupervised learning models, one or more supervised learning models, one or more time series models, one or more ensemble models, one or more rule-based detection algorithms, and/or one or more natural language processing (NLP) models. Such features can include, e.g., user role, which differentiates between admin, developer, guest users, etc., event type, which captures operations such as ACCESS, CREATE, DELETE, etc., resource type, which distinguishes sensitive resources from less critical resources, geo-location, which identifies unusual geographic locations for user actions, and one or more temporal features, which track the hour of day, day of week, etc. for time-based anomaly patterns. Accordingly, such an embodiment includes enhancing anomaly detection by learning and/or understanding the context of an event, such as, e.g., whether an admin accessing a sensitive resource aligns with normal behavior or is anomalous based on one or more historical patterns.

Additionally or alternatively, in accordance with one or more embodiments, anomaly detection includes implementing risk scoring techniques. In such an embodiment, anomaly score calculations can be carried out, wherein each log entry is assigned an anomaly score (e.g., a numeric value indicating how abnormal the corresponding behavior is, wherein, for example, higher scores can correspond to more abnormal activity). Entries can be classified into an anomaly category or a normal category based at least in part on the predictions from the isolation forest model. Accordingly, such an embodiment includes determining and/or providing a quantified risk level for each log entry, facilitating focused action on the most concerning anomalies.

One or more embodiments also include initiated and/or executing one or more automated actions in response to one or more detected anomalies (e.g., to mitigate one or more potential security risks). Specific automated response actions can include, for example, automatically locking a user account, automatically isolating resources, and/or identifying or flagging an anomaly for further analysis. With respect to locking a user account, at least one embodiment can include identifying the user_id associated with the anomaly, logging the action and adding the user_id to a locked users list and/or data structure, which can prevent further malicious and/or accidental activity from the identified user.

With respect to isolating resources, at least one embodiment can include isolating sensitive resources (e.g., secrets, critical services, etc.) associated with the anomaly by logging the resource isolation and adding the resource to an isolated resources list and/or data structure, which can secure particular resources (e.g., critical resources) from unauthorized and/or potentially harmful access. Further, with respect to flagging an anomaly for further analysis, at least one embodiment can include generating and transmitting an alert for a flagged anomaly to at least one review queue (e.g., within a designated data structure), wherein such an alert captures detailed information about the anomaly including, for example, event_id, user_id, resource_name, and related log details. Such an embodiment includes enabling and/or ensuring that suspicious activities are investigated by security systems and/or teams for further analysis.

One or more embodiments also include performing actionable and/or dynamic logging, which includes logging particular (e.g., important) events, such as detected anomalies, locked accounts, isolated resources, etc., for auditing and tracking purposes. Outputs associated with such dynamic logging can include, e.g., anomaly_score, which indicates the numeric anomaly score for each entry, is_anomaly, which labels entries as “anomaly” or “normal,” and response, which details one or more automated responsive actions carried out (e.g., account locked, resource isolated, and/or flagged for review).

By way merely of illustration, consider the following example of processed log data in accordance with one or more embodiments.

Log Entry 1: Admin user (user12) from Toronto attempts to access a secret but is denied. Detected as an anomaly due to denied access to a critical resource from an unexpected location.

Log Entry 2: Developer user (user45) from Austin successfully creates a pod in the non-production namespace. Classified as normal because it aligns with expected behavior for a developer.

Log Entry 3: Guest user (user78) from Mumbai attempts to delete a service but is denied. Detected as an anomaly due to unauthorized delete attempt by a guest user on a critical resource.

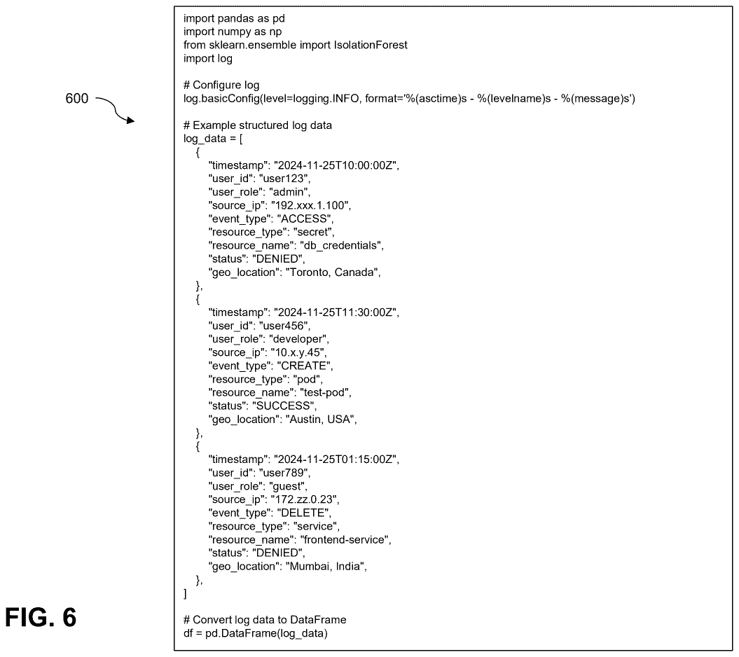

FIG. 6 shows example pseudocode for configuring log data and converting log data to a data frame in an illustrative embodiment. In this embodiment, example pseudocode 600 is executed by or under the control of at least one processing system and/or device. For example, the example pseudocode 600 may be viewed as comprising a portion of a software implementation of at least part of container-related access control and anomaly detection system 105 of the FIG. 1 embodiment.

The example pseudocode 600 illustrates importing necessary libraries, and importing as well as configuring certain log data. Example pseudocode 600 also illustrates examples of structured log data, and steps for converting the log data to at least one data frame.

It is to be appreciated that this particular example pseudocode shows just one example implementation of configuring log data and converting log data to a data frame, and alternative implementations can be used in other embodiments.

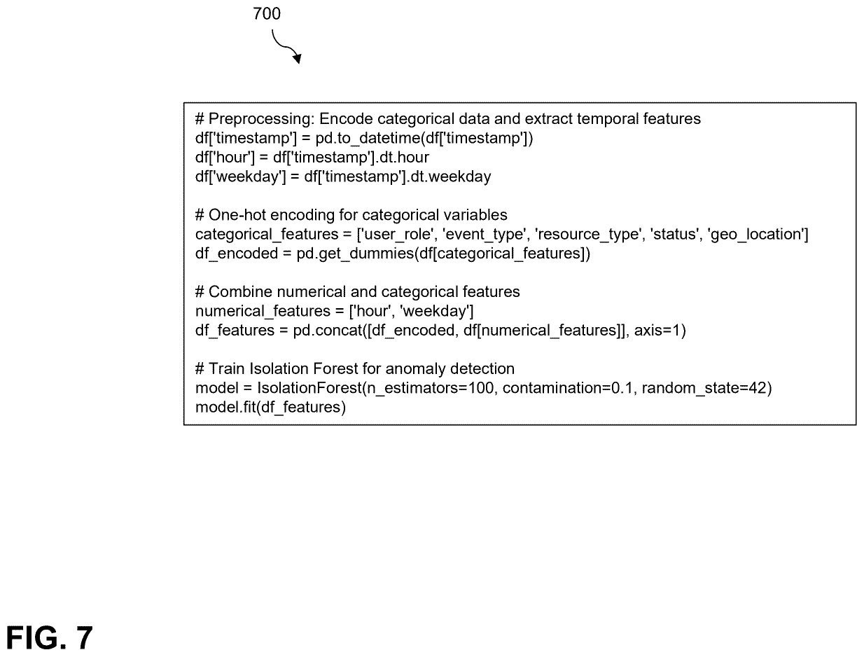

FIG. 7 shows example pseudocode for training an isolation forest algorithm in an illustrative embodiment. In this embodiment, example pseudocode 700 is executed by or under the control of at least one processing system and/or device. For example, the example pseudocode 700 may be viewed as comprising a portion of a software implementation of at least part of container-related access control and anomaly detection system 105 of the FIG. 1 embodiment.

The example pseudocode 700 illustrates preprocessing categorical data, encoding at least a portion of the preprocessed categorical data, and creating training data by combining one or more categorical features with one or more numerical features. Also, example pseudocode 700 illustrates training an isolation forest algorithm for anomaly detection using the training data.

It is to be appreciated that this particular example pseudocode shows just one example implementation of training an isolation forest algorithm, and alternative implementations can be used in other embodiments.

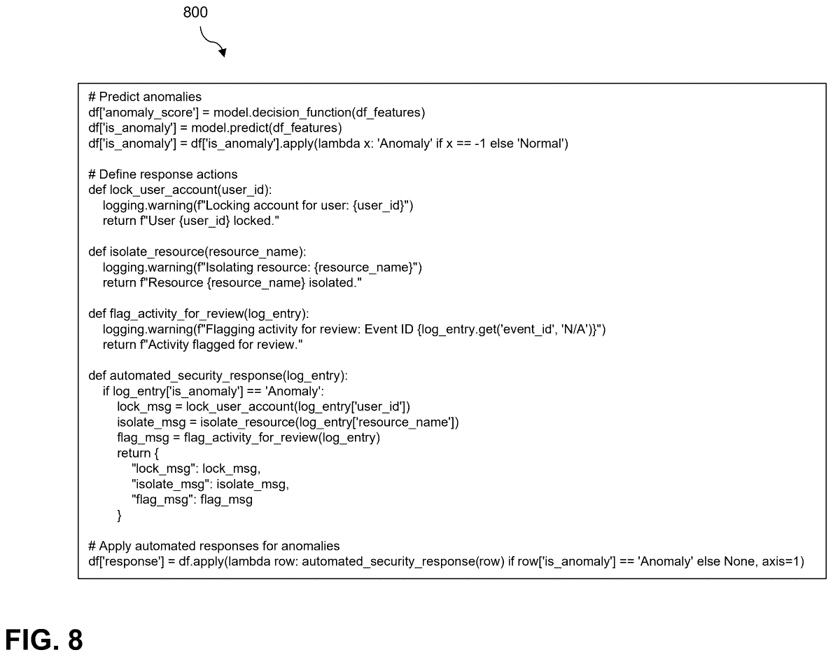

FIG. 8 shows example pseudocode for implementing the trained isolation forest algorithm for anomaly detection in an illustrative embodiment. In this embodiment, example pseudocode 800 is executed by or under the control of at least one processing system and/or device. For example, the example pseudocode 800 may be viewed as comprising a portion of a software implementation of at least part of container-related access control and anomaly detection system 105 of the FIG. 1 embodiment.

The example pseudocode 800 illustrates predicting anomalies in input data using the trained isolation forest algorithm. Additionally, example pseudocode 800 illustrates defining response actions and applying at least a portion of the response actions to the predicted anomalies.

It is to be appreciated that this particular example pseudocode shows just one example implementation of the trained isolation forest algorithm for anomaly detection, and alternative implementations can be used in other embodiments.

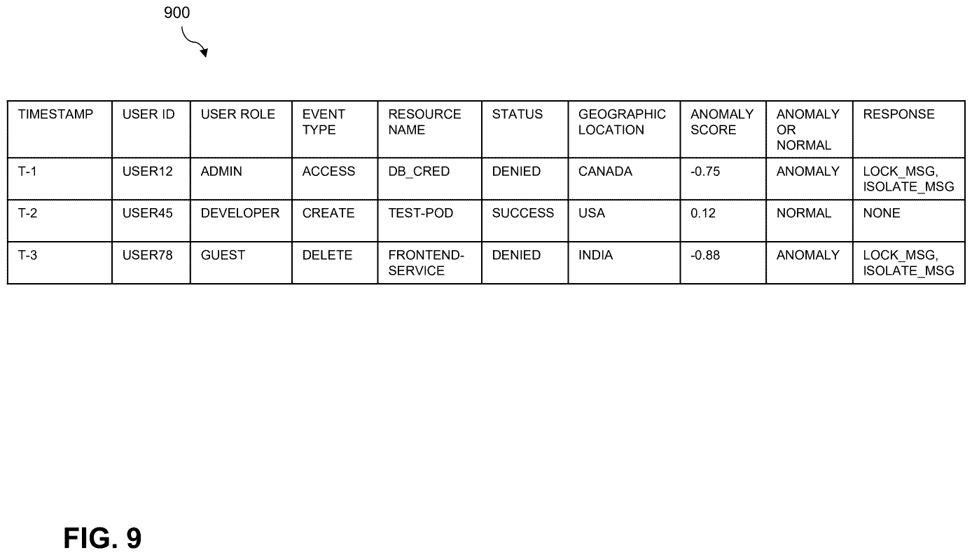

FIG. 9 shows an example output table in an illustrative embodiment. By way of illustration, example output table 900 includes columns pertaining to timestamp information, user identifier (ID), user role information, event type, resource name, status, geographic location of event, anomaly score, anomaly status, and response. By way of example, in connection with example output table 900, the following messages appear in the log file:

For Row 1 (associated with a first potential anomaly): WARNING—Locking account for user: user12; INFO-User12 has been locked; WARNING—Isolating resource: db_credentials; INFO—Resource db_credentials has been isolated; WARNING—Flagging activity for review: Event ID N/A; INFO—Activity flagged for review: {...} #Details of the log entry.

For Row 2 (associated with a second potential anomaly): No output as the activity is normal.

For Row 3 (associated with a third potential anomaly): WARNING—Locking account for user: user78; INFO—User user78 has been locked; WARNING—Isolating resource: frontend-service; INFO—Resource frontend-service has been isolated; WARNING—Flagging activity for review: Event ID N/A; INFO—Activity flagged for review: {...} #Details of the log entry.

FIG. 10 is a flow diagram of a process for container orchestration platform-related access control and anomaly detection using artificial intelligence in an illustrative embodiment. It is to be understood that this particular process is only an example, and additional or alternative processes can be carried out in other embodiments.

In this embodiment, the process includes steps 1000 through 1006. These steps are assumed to be performed by the container-related access control and anomaly detection system 105 utilizing elements 112, 114 and 116.

Step 1000 includes processing, using at least one RBAC operator, one or more cluster changes within at least one container orchestration platform. In at least one embodiment, processing one or more cluster changes within at least one container orchestration platform includes processing cluster role information associated with multiple API resources. Additionally or alternatively, processing one or more cluster changes within at least one container orchestration platform can include processing one or more cluster changes within at least one multi-tenant Kubernetes environment.

Step 1002 includes updating one or more permissions granted to one or more namespace users, within the at least one container orchestration platform, in response to at least a portion of the one or more cluster changes. In one or more embodiments, updating one or more permissions granted to one or more namespace users includes adjusting role information and permission information associated with at least a portion of the one or more namespace users upon determination of at least of one or more resources added to at least one cluster and one or more resources removed from at least one cluster.

Step 1004 includes identifying, in accordance with the one or more updated permissions, anomalous operation-related activity within the at least one container orchestration platform using one or more artificial intelligence-based anomaly detection techniques. In at least one embodiment, identifying anomalous operation-related activity within the at least one container orchestration platform includes classifying each of one or more operations within the at least one container orchestration platform as one of anomalous and non-anomalous by processing data pertaining to the one or more operations using at least one isolation forest model. Additionally or alternatively, identifying anomalous operation-related activity within the at least one container orchestration platform can include identifying one or more unauthorized operations by processing one or more container orchestration platform audit logs using the one or more artificial intelligence-based anomaly detection techniques.

Further, in at least one embodiment, identifying anomalous operation-related activity within the at least one container orchestration platform can include using the one or more artificial intelligence-based anomaly detection techniques in conjunction with at least one multi-feature correlation technique by incorporating multiple contextual features into the one or more artificial intelligence-based anomaly detection techniques. In such an embodiment, incorporating multiple contextual features into the one or more artificial intelligence-based anomaly detection techniques can include incorporating, into the one or more artificial intelligence-based anomaly detection techniques, two or more of at least one user role feature, at least one operation type feature, at least one resource type feature, at least one geo-location feature, and at least one temporal feature.

Step 1006 includes performing one or more automated actions in response to at least a portion of the identified anomalous operation-related activity. In one or more embodiments, performing one or more automated actions includes automatically locking at least one user account associated with the identified anomalous operation-related activity. In such an embodiment, automatically locking at least one user account associated with the identified anomalous operation-related activity can include identifying a user account identifier associated with the identified anomalous operation-related activity and adding the user account identifier to at least one data structure corresponding to locked user accounts. Additionally or alternatively, performing one or more automated actions can include automatically isolating one or more resources associated with the identified anomalous operation-related activity. Further, in one or more embodiments, performing one or more automated actions can include automatically training at least a portion of the one or more artificial intelligence-based anomaly detection techniques using feedback related to the at least a portion of the identified anomalous operation-related activity.

Accordingly, the particular processing operations and other functionality described in conjunction with the flow diagram of FIG. 10 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to maintain updated namespace permissions information and automatically detect operations-related anomalies in association therewith. These and other embodiments can effectively overcome problems associated with data loss, latencies and/or other security issues arising from failure to implement preventative measures with respect to security breaches.

It is to be appreciated that the particular advantages described above and elsewhere herein are associated with particular illustrative embodiments and need not be present in other embodiments. Also, the particular types of information processing system features and functionality as illustrated in the drawings and described above are examples only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

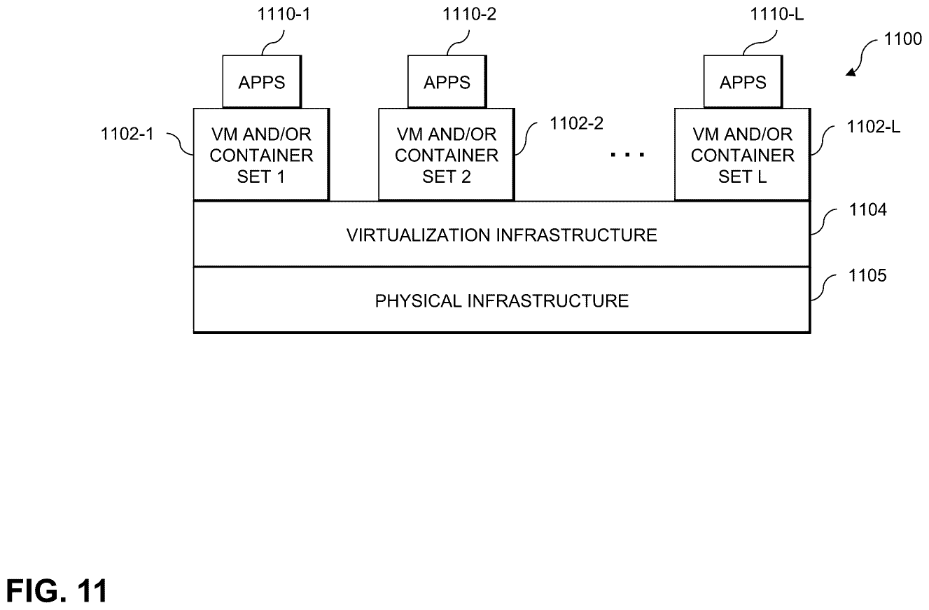

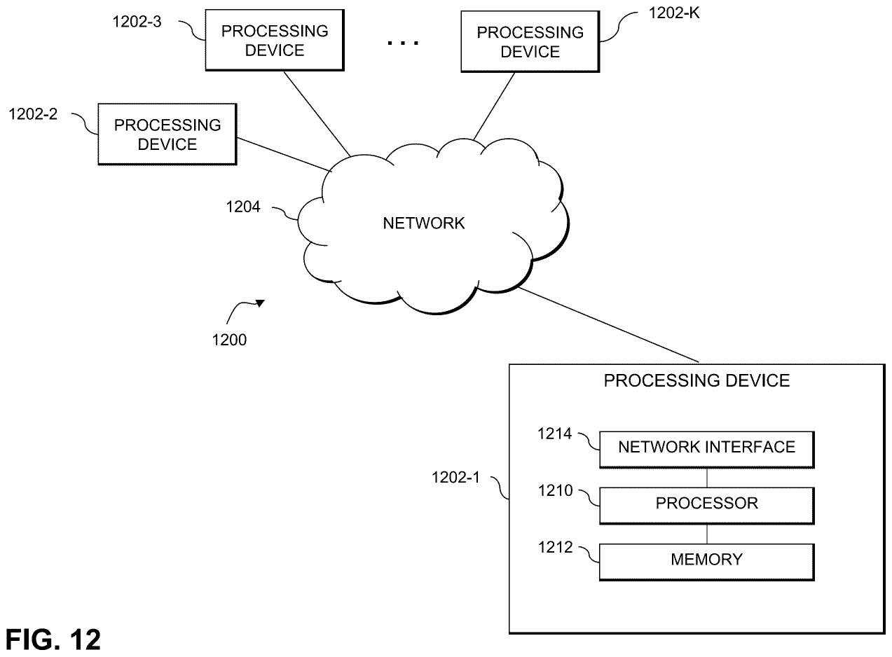

Illustrative embodiments of processing platforms will now be described in greater detail with reference to FIGS. 11 and 12. Although described in the context of system 100, these platforms may also be used to implement at least portions of other information processing systems in other embodiments.

FIG. 11 shows an example processing platform comprising cloud infrastructure 1100. The cloud infrastructure 1100 comprises a combination of physical and virtual processing resources that are utilized to implement at least a portion of the information processing system 100. The cloud infrastructure 1100 comprises multiple virtual machines (VMs) and/or container sets 1102-1, 1102-2, . . . 1102-L implemented using virtualization infrastructure 1104. The virtualization infrastructure 1104 runs on physical infrastructure 1105, and illustratively comprises one or more hypervisors and/or operating system level virtualization infrastructure. The operating system level virtualization infrastructure illustratively comprises kernel control groups of a Linux operating system or other type of operating system.

The cloud infrastructure 1100 further comprises sets of applications 1110-1, 1110-2, . . . 1110-L running on respective ones of the VMs/container sets 1102-1, 1102-2, . . . 1102-L under the control of the virtualization infrastructure 1104. The VMs/container sets 1102 comprise respective VMs, respective sets of one or more containers, or respective sets of one or more containers running in VMs. In some implementations of the FIG. 11 embodiment, the VMs/container sets 1102 comprise respective VMs implemented using virtualization infrastructure 1104 that comprises at least one hypervisor.

A hypervisor platform may be used to implement a hypervisor within the virtualization infrastructure 1104, wherein the hypervisor platform has an associated virtual infrastructure management system. The underlying physical machines comprise one or more information processing platforms that include one or more storage systems.

In other implementations of the FIG. 11 embodiment, the VMs/container sets 1102 comprise respective containers implemented using virtualization infrastructure 1104 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1100 shown in FIG. 11 may represent at least a portion of one processing platform. Another example of such a processing platform is processing platform 1200 shown in FIG. 12.

The processing platform 1200 in this embodiment comprises a portion of system 100 and includes a plurality of processing devices, denoted 1202-1, 1202-2, 1202-3, . . . 1202-K, which communicate with one another over a network 1204.

The network 1204 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1202-1 in the processing platform 1200 comprises a processor 1210 coupled to a memory 1212.

The processor 1210 comprises a microprocessor, an ASIC, an SOC, an FPGA, a CPU, a GPU, an NPU, a DPU, a TPU, an ALU, a DSP, and/or other similar processing device components, as well as other types and arrangements of processing circuitry, in any combination. At least a portion of the functionality of at least one artificial intelligence system and its associated artificial intelligence algorithms provided by one or more processing devices as disclosed herein can be implemented using such circuitry.

The memory 1212 comprises RAM, ROM or other types of memory, in any combination. The memory 1212 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1202-1 is network interface circuitry 1214, which is used to interface the processing device with the network 1204 and other system components, and may comprise conventional transceivers.

The other processing devices 1202 of the processing platform 1200 are assumed to be configured in a manner similar to that shown for processing device 1202-1 in the figure.

Again, the particular processing platform 1200 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as examples rather than as requirements or limitations of the disclosure. Numerous other alternative embodiments within the scope of the appended claims will be readily apparent to those skilled in the art.

What is claimed is:

1. A computer-implemented method comprising:
processing, using at least one role-based access control (RBAC) operator, one or more cluster changes within at least one container orchestration platform;
updating one or more permissions granted to one or more namespace users, within the at least one container orchestration platform, in response to at least a portion of the one or more cluster changes;
identifying, in accordance with the one or more updated permissions, anomalous operation-related activity within the at least one container orchestration platform using one or more artificial intelligence-based anomaly detection techniques; and
performing one or more automated actions in response to at least a portion of the identified anomalous operation-related activity;
wherein the method is performed by at least one processing device comprising a processor coupled to a memory.

2. The computer-implemented method of claim 1, wherein identifying anomalous operation-related activity within the at least one container orchestration platform comprises classifying each of one or more operations within the at least one container orchestration platform as one of anomalous and non-anomalous by processing data pertaining to the one or more operations using at least one isolation forest model.

3. The computer-implemented method of claim 1, wherein performing one or more automated actions comprises automatically locking at least one user account associated with the identified anomalous operation-related activity.

4. The computer-implemented method of claim 3, wherein automatically locking at least one user account associated with the identified anomalous operation-related activity comprises identifying a user account identifier associated with the identified anomalous operation-related activity and adding the user account identifier to at least one data structure corresponding to locked user accounts.

5. The computer-implemented method of claim 1, wherein performing one or more automated actions comprises automatically isolating one or more resources associated with the identified anomalous operation-related activity.

6. The computer-implemented method of claim 1, wherein processing one or more cluster changes within at least one container orchestration platform comprises processing cluster role information associated with multiple application programming interface (API) resources.

7. The computer-implemented method of claim 1, wherein updating one or more permissions granted to one or more namespace users comprises adjusting role information and permission information associated with at least a portion of the one or more namespace users upon determination of at least of one or more resources added to at least one cluster and one or more resources removed from at least one cluster.

8. The computer-implemented method of claim 1, wherein identifying anomalous operation-related activity within the at least one container orchestration platform comprises identifying one or more unauthorized operations by processing one or more container orchestration platform audit logs using the one or more artificial intelligence-based anomaly detection techniques.

9. The computer-implemented method of claim 1, wherein identifying anomalous operation-related activity within the at least one container orchestration platform comprises using the one or more artificial intelligence-based anomaly detection techniques in conjunction with at least one multi-feature correlation technique by incorporating multiple contextual features into the one or more artificial intelligence-based anomaly detection techniques.

10. The computer-implemented method of claim 9, wherein incorporating multiple contextual features into the one or more artificial intelligence-based anomaly detection techniques comprises incorporating, into the one or more artificial intelligence-based anomaly detection techniques, two or more of at least one user role feature, at least one operation type feature, at least one resource type feature, at least one geo-location feature, and at least one temporal feature.

11. The computer-implemented method of claim 1, wherein processing one or more cluster changes within at least one container orchestration platform comprises processing one or more cluster changes within at least one multi-tenant Kubernetes environment.

12. The computer-implemented method of claim 1, wherein performing one or more automated actions comprises automatically training at least a portion of the one or more artificial intelligence-based anomaly detection techniques using feedback related to the at least a portion of the identified anomalous operation-related activity.

13. A non-transitory processor-readable storage medium having stored therein program code of one or more software programs, wherein the program code when executed by at least one processing device causes the at least one processing device:
to process, using at least one role-based access control (RBAC) operator, one or more cluster changes within at least one container orchestration platform;
to update one or more permissions granted to one or more namespace users, within the at least one container orchestration platform, in response to at least a portion of the one or more cluster changes;
to identify, in accordance with the one or more updated permissions, anomalous operation-related activity within the at least one container orchestration platform using one or more artificial intelligence-based anomaly detection techniques; and
to perform one or more automated actions in response to at least a portion of the identified anomalous operation-related activity.

14. The non-transitory processor-readable storage medium of claim 13, wherein identifying anomalous operation-related activity within the at least one container orchestration platform comprises classifying each of one or more operations within the at least one container orchestration platform as one of anomalous and non-anomalous by processing data pertaining to the one or more operations using at least one isolation forest model.

15. The non-transitory processor-readable storage medium of claim 13, wherein performing one or more automated actions comprises automatically locking at least one user account associated with the identified anomalous operation-related activity.

16. The non-transitory processor-readable storage medium of claim 13, wherein performing one or more automated actions comprises automatically isolating one or more resources associated with the identified anomalous operation-related activity.

17. An apparatus comprising:
at least one processing device comprising a processor coupled to a memory;
the at least one processing device being configured:
to process, using at least one role-based access control (RBAC) operator, one or more cluster changes within at least one container orchestration platform;
to update one or more permissions granted to one or more namespace users, within the at least one container orchestration platform, in response to at least a portion of the one or more cluster changes;
to identify, in accordance with the one or more updated permissions, anomalous operation-related activity within the at least one container orchestration platform using one or more artificial intelligence-based anomaly detection techniques; and
to perform one or more automated actions in response to at least a portion of the identified anomalous operation-related activity.

18. The apparatus of claim 17, wherein identifying anomalous operation-related activity within the at least one container orchestration platform comprises classifying each of one or more operations within the at least one container orchestration platform as one of anomalous and non-anomalous by processing data pertaining to the one or more operations using at least one isolation forest model.

19. The apparatus of claim 17, wherein performing one or more automated actions comprises automatically locking at least one user account associated with the identified anomalous operation-related activity.

20. The apparatus of claim 17, wherein performing one or more automated actions comprises automatically isolating one or more resources associated with the identified anomalous operation-related activity.
